(19) United States
(12) Patent Application Publication
(10) Pub. No.: US 2019/0346733 A1
(43) Pub. Date: Nov. 14, 2019

(54) SMART WIDOW SYSTEM INCLUDING ENERGY STORAGE UNIT AND METHODS OF USING SAME

(71) Applicant: HELIOTROPE TECHNOLOGIES, INC., Alameda, CA (US)

(72) Inventors: Jason HOLT, Larkspur, CA (US); Guillermo GARCIA, Oakland, CA (US); Lyle KAPLAN-REINIG, San Jose, CA (US); Peter GREEN, Phoenix, AZ (US); David ENGLAND, Warrington (GB)

(21) Appl. No.: 16/406,362

(22) Filed: May 8, 2019

Related U.S. Application Data
(60) Provisional application No. 62/669,466, filed on May 10, 2018.

(51) Int. Cl. G02F 1/163; H02M 3/04; H02S 20/20; H02J 7/35; E06B 9/24

(52) U.S. Cl. CPC G02F 1/163; H02M 3/04; H02J 7/345; H02J 7/35; E06B 9/24; H02S 20/20

(57) ABSTRACT

A method of operating an electrochromic (EC) device includes storing energy generated by the EC device during a change in optical state of the EC device.

### FIELD

The present invention is generally directed to electrochromic systems, and more particularly to electrochromic systems which include integrated power generation and/or energy storage devices.

### BACKGROUND OF THE INVENTION

Residential and commercial buildings represent a prime opportunity to improve energy efficiency and sustainability in the United States. The buildings sector alone accounts for 40% of the United States' yearly energy consumption (40 quadrillion BTUs, or “quads”, out of 100 total), and 8% of the world's energy use. Lighting and thermal management each represent about 30% of the energy used within a typical building, which corresponds to around twelve quads each of yearly energy consumption in the US. Windows cover an estimated area of about 2,500 square km in the US and are a critical component of building energy efficiency as they strongly affect the amount of natural light and solar gain that enters a building. Recent progress has been made toward improving window energy efficiency through the use of inexpensive static coatings that either retain heat in cold climates (low emissive films) or reject solar heat gain in warm climates (near-infrared rejection films).

Currently, static window coatings can be manufactured at relatively low cost. However, these window coatings are static and not well suited for locations with varying climates. An electrochromic (EC) window coating overcomes these limitations by enhancing the window performance in all climates. Electrochromic window coatings undergo a reversible change in optical properties when driven by an applied potential.

### SUMMARY

According to various embodiments, a smart window system includes an electrochromic (EC) device having a bright optical state and a dark optical state, a DC/DC power converter electrically connected to the EC device and configured to operate in a buck mode and a boost mode, and an energy storage device electrically connected to the power converter. In the buck mode, the power converter is configured to decrease a voltage provided through the power converter to the EC device, and in the boost mode, the power converter is configured to increase a voltage provided from the EC device to the energy storage device.

According to various embodiments, a method of operating an electrochromic (EC) device, comprises storing energy generated by the EC device during a change in optical state of the EC device.

According to various embodiments, a smart window system includes an electrochromic (EC) device having a bright optical state and a dark optical state, an energy storage device electrically connected to the power converter, and a conversion means for increasing a voltage provided to the EC device in a buck mode, and for increasing a voltage provided from the EC device to the energy storage device in a boost mode.

### BRIEF DESCRIPTION OF THE DRAWINGS

FIG. 1 is a schematic representation of a building control system according to various embodiments of the present disclosure.

FIGS. 2A-2C are schematic representations of electrochromic devices according to various embodiments of the present disclosure.

FIG. 3 is a schematic representation of a smart window system according to various embodiments of the present disclosure.

FIG. 4 is a schematic view of a power control system according to various embodiments of the present disclosure.

### DETAILED DESCRIPTION OF THE EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being disposed “on” or “connected to” another element or layer, it can be directly on or directly connected to the other element or layer, or intervening elements or layers may be present. In contrast, when an element is referred to as being disposed “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Electrochromic devices may be incorporated into, for example, windows for commercial and/or residential buildings. Such electrochromic windows may be operated independently, or as part of an integrated building management system. However, the building may lose power which results in an inoperability of the electrochromic device. The use of one or more power generation device (e.g., a photovoltaic device) as a power source may dramatically reduce the cost and complexity in a system that includes electrochromic windows.

In various embodiments, a building or other facility may have at least one window that contains one or more electrochromic device. In various embodiments, the optical state of an electrochromic device within a building window may be controlled by a system that receives voltage generated by one or more power generation device that is integrated in or attached to the electrochromic window.

The terms “smart window,” “electrochromic window,” and “insulating glass unit” (IGU) are used interchangeably herein to refer to a window unit that contains at least one glass pane, one or more power generation device, and one or more electrochromic device. In some embodiments, the electrochromic device(s) may be a coating deposited on a substrate. The power generation device(s) included in the smart window may produce a current or voltage that is supplied to a control unit. In various embodiments, the current or voltage may be produced in response to external conditions. In various embodiments, power generation devices may include, for example, photovoltaic devices, piezoelectric power generation devices, thermoelectric devices, radio frequency (RF) receivers, and/or other devices that produce voltage or current in response to a sensed condition(s). The term “smart window system” refers to one or more smart window and associated components (e.g., a controller, wiring/connectors, a frame, etc.).

In some embodiments, as discussed in further detail below, the power generation device(s) may also function as a sensor, and may comprise multiple sensors provided in an array, referred to as a “sensing module.”

The control unit may be configured with logic to direct the electrical current generated by the power generation device, e.g. sensing module. Specifically, the control unit may include a switch that enables the electrochromic device to either draw power from the generated current or from a battery. Accordingly, the electrical current generated by the power generation device may be optionally used to charge a battery that is connected to the electrochromic device, or may be applied directly to the electrochromic device. In another embodiment, the electrical current generated by the power generation device may be provided to power another building system (e.g., interior lighting, security, etc.).

The control unit may in turn output instructions that direct application of a particular voltage to the electrochromic device. In some embodiments, the control unit may be one of a number of intermediate units, each of which may provide sensor information from one or more smart window to a building control system. In some embodiments, the building control system may provide instructions directing application of a voltage to a particular electrochromic device based on received sensor information from a plurality of smart windows, such as those adjacent to the smart window housing the particular electrochromic device. In various embodiments, an intermediate control unit or building master control unit may be configured to receive input from a plurality of different types of sensors.

In alternative embodiments, data from the smart windows may be used for purposes other than controlling the electrochromic devices therein. For example, the building master control unit may be configured to receive sensor information from one or more smart windows, and to provide information to other devices within or outside of the building control system. In some embodiments, the building master control unit may be part of a network connected to a cloud service platform where application software stores, processes, analyzes, distributes and displays information. The software may be used, either by a user or automatically, to supply power to control systems or devices based on the environmental data detected by sensors, which may be part of or separate from the power generation device.

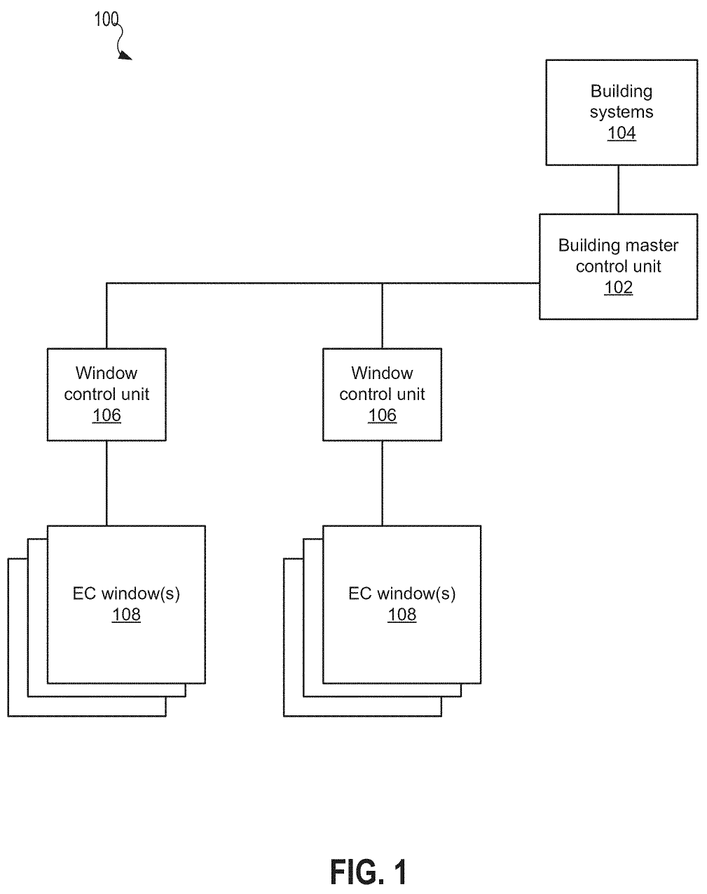

FIG. 1 illustrates an example building control system 100 that may centrally manage a number of networked systems, including smart windows. In various embodiments, the building control system 100 may include a building master control unit 102, which may monitor and control systems one or more building system 104. Building systems 104 that may be part of the building control system 100 include, but are not limited to, systems that regulate air temperature (e.g., heating/ventilation/air conditioning (HVAC)), power (e.g., main power, backup power generators, uninterrupted power source (UPS) grids, etc.), lighting (interior/exterior lights, emergency warning lights, etc.), CO₂ detection, security (e.g., door locks, magnetic card access, surveillance cameras, alarms, etc.), fire safety (e.g., alarms, fire suppression systems, etc.). The building systems 104 may be controlled for the building as a whole, for various floors, and/or for individual rooms. In various embodiments, the building master control unit 102 may be coupled, by wired or wireless connections, to each building system 104.

In addition, the building master control unit 102 may manage at least one window control unit 106, each of which controls one or more smart window 108. In one embodiment, the window control unit 106 may be an end control unit that controls one smart window unit 108. For example, while building control system 100 is shown as including two window control units 106, in some embodiments the functions of both window control units 106 may be provided by a single unit. In other embodiments, the functions performed by the window control units 106 may be divided across three or more units. The system 100 may include a single window control unit that performs the functions of both window control units 106 and/or may include a distributed network of window control units 106, which may be connected to windows through one or more intermediate and/or end controller. For example, a window control unit 106 may be in proximity to the building master control unit 102, with each floor of the building having one or more intermediate controller and each window having an end controller.

Connections between the building master control unit 102 and at least one window control unit 106, as well as connections among the window control units 106 (e.g., intermediate controllers and end controllers) in the building control system 100 may be wired or wireless.

Accordingly, while control of smart windows may be described herein with respect to a window control unit (e.g., 106), the various operations may be performed by an end controller directly coupled to the smart window and/or by a control unit that manages multiple end controllers and/or smart windows (e.g., an intermediate controller).

In various embodiments, a window control unit may receive output signals from one or more power generation device, and determine an amount of voltage or current to apply across one or more electrochromic device using a predetermined relationship between the received output signals and the desired optical properties of the smart window.

In various embodiments, the electrochromic devices may include EC nanostructured materials capable of selectively modulating radiation in near-infrared (NIR) and visible spectral regions. The materials may be provided on electrochromic window coatings may include nanostructured doped transition metal oxides with ternary compounds of the type AxMzOy. In various embodiment AxMzOy compounds, if it is assumed that z=1, then 0≤×≤0.5 (preferably 0.25≤×≤0.35), and 2≤y≤3. In various embodiments, since the nanostructures may be non-uniform as a function of depth, x may represent an average doping content. To operate, the subject material may be fabricated into an electrode that will change optical properties after driven by an applied voltage.

In order to improve the performance of electrochromic window coatings, selective modulation of NIR and visible spectra radiation, and avoidance of degrading effects of UV radiation, may be desired. Various embodiments may include single-component electrochromic nanostructured materials capable of selectively modulating NIR and visible spectral regions. Further, since certain spectral regions may damage the electrochromic nanostructured material, the various embodiments may incorporate at least one protective material and/or protective layer to prevent such damage.

The various embodiments provide devices and methods for enhancing optical changes in windows using electrochromic nanostructured materials fabricated into an electrode to form an electrochromic device. In various embodiments, the material may undergo a reversible change in optical properties when driven by an applied potential. Based on the applied potential, the electrochromic nanostructured materials may modulate NIR radiation (wavelength of around 780-2500 nm), as well as visible radiation (wavelength of around 400-780 nm). In an example, the device may include a first nanostructured material that modulates radiation in a portion of the NIR spectral region and in the visible spectral region, and a second nanostructured material that modulates radiation in an overlapping portion of the NIR spectral region such that the NIR radiation modulated by the device as a whole is enhanced and expanded relative to that of just the first nanostructured material. In various embodiments, the material may operate in multiple selective modes based on the applied potential.

Accordingly, the various embodiments may include at least one protective material to prevent or reduce damage to an electrochromic nanostructured material that may result from repeated exposure to radiation in the UV spectral region. In an example, a protective material may be used to form at least one barrier layer in the device that is positioned to block UV radiation from reaching the first nanostructured material and electrolyte. In another example, a protective material may be used to form a layer that is positioned to block free electron or hole charge carriers created in the electrolyte due to absorption of UV radiation by the nanostructured electrode material from migrating to that material, while allowing conduction of ions from the electrolyte (i.e., an electron barrier and ion conductor).

In various embodiments, control of individual operating modes for modulating absorption/transmittance of radiation in specific spectral regions may occur at different applied biases. Such control may provide users with the capability to achieve thermal management within buildings and other enclosures (e.g., vehicles, etc.), while still providing shading when desired.

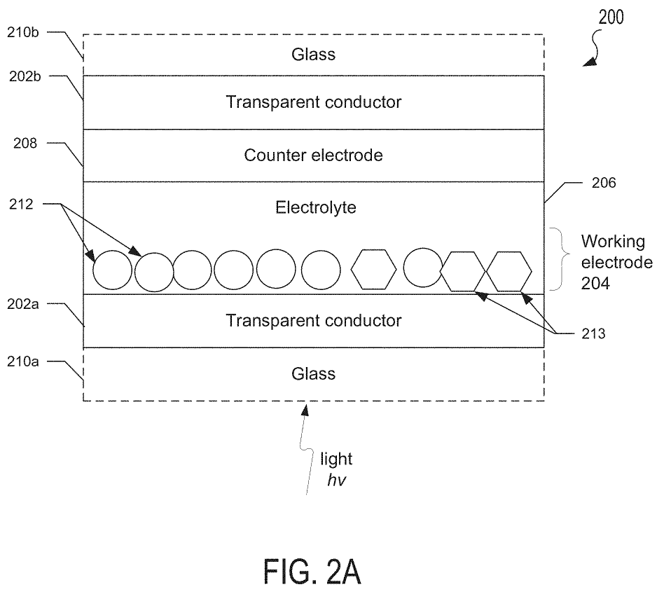

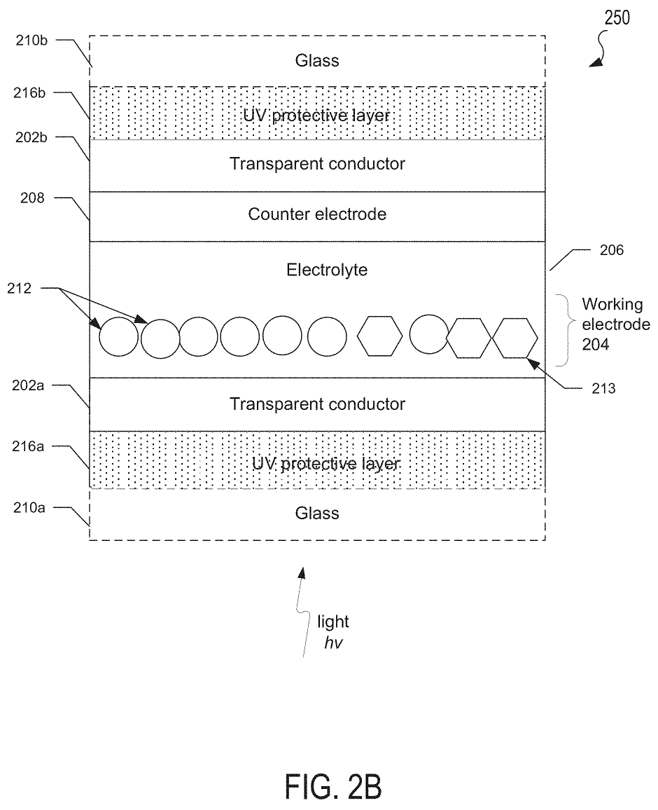

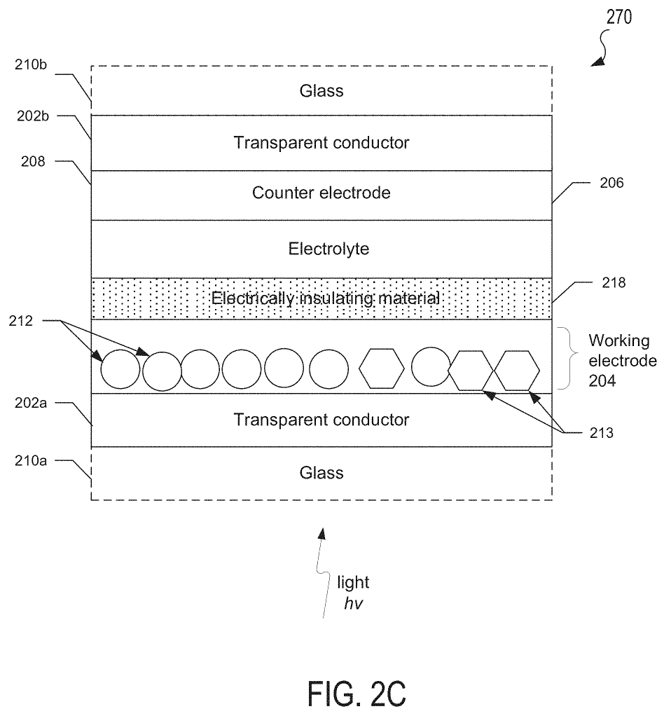

FIGS. 2A-2C illustrate exemplary electrochromic devices. It should be noted that such electrochromic devices may be oriented upside down or sideways from the orientations illustrated in FIGS. 2A-2C. Furthermore, the thickness of the layers and/or size of the components of the devices in FIGS. 2A-2C are not drawn to scale or in actual proportion to one another other, but rather are shown as representations.

In FIG. 2A, an exemplary electrochromic device 200 may include a first transparent conductor layer 202a, a working electrode 204, a solid state electrolyte 206, a counter electrode 208, and a second transparent conductor layer 202b. Some embodiment electrochromic devices may also include first and second light transmissive substrates 210a, 210b respectively positioned in front of the first transparent conductor layer 202a and/or positioned behind the second transparent conductor layer 202b. The first and second substrates 210a, 210b may be formed of a transparent material such as glass or plastic.

The first and second transparent conductor layers 202a, 202b may be formed from transparent conducting films fabricated using inorganic and/or organic materials. For example, the transparent conductor layers 202a, 202b may include inorganic films of transparent conducting oxide (TCO) materials, such as indium tin oxide (ITO) or fluorine doped tin oxide (FTO). In other examples, organic films in transparent conductor layers 202a, 202b may include graphene and/or various polymers.

In the various embodiments, the working electrode 204 may include a nanostructured electrochemically-active material, such as nanostructures 212 of a doped or undoped transition metal oxide bronze, as well as nanostructures 213 of a transparent conducting oxide (TCO) composition shown schematically as circles and hexagons for illustration purposes only. As discussed above, the thickness of the layers of the device 200, including and the shape, size and scale of nanostructures is not drawn to scale or in actual proportion to each other, but is represented for clarity. In the various embodiments, nanostructures 212, 213 may be embedded in an optically transparent matrix material or provided as a packed or loose layer of nanostructures exposed to the electrolyte. In the various embodiments, the doped or undoped transition metal oxide bronze of nanostructures 212 may be a ternary composition of the type AxMzOy, where M represents a transition metal ion species in at least one transition metal oxide, and A represents at least one dopant. Transition metal oxides that may be used in the various embodiments include, but are not limited to, any transition metal oxide which can be reduced and has multiple oxidation states, such as niobium oxide, tungsten oxide, molybdenum oxide, vanadium oxide, titanium oxide and mixtures of two or more thereof. In one example, the nanostructured transition metal oxide bronze may include a plurality of tungsten oxide (WO₃₋ₓ,) nanoparticles, where 0≤x≤0.33, such as 0≤x≤0.1.

In various embodiments, the at least one dopant species may be a first dopant species that, upon application of a particular first voltage range, causes a first optical response. The applied voltage may be, for example, a negative bias voltage. Specifically, the first dopant species may cause a surface plasmon resonance effect on the transition metal oxide by creating a significant population of delocalized electronic carriers. Such surface plasmon resonance may cause absorption of NIR radiation at wavelengths of around 780-2000 nm, with a peak absorbance at around 1200 nm. In various embodiments, the specific absorbances at different wavelengths may be varied/adjusted based other factors (e.g., nanostructure shape, size, etc.), discussed in further detail below. In the various embodiments, the first dopant species may be an ion species selected from the group of cesium, rubidium, and lanthanides (e.g., cerium, lanthanum, praseodymium, neodymium, promethium, samarium, europium, gadolinium, terbium, dysprosium, holmium, erbium, thulium, ytterbium, and lutetium). In alternative embodiments, the nanostructures 212 may be an undoped transition metal oxide bronze that does not include a first dopant species.

In various embodiments, the dopant may include a second dopant species that causes a second optical response based upon application of a voltage within a different, second particular range. The applied voltage may be, for example, a negative bias voltage. In an embodiment, the second dopant species may migrate between the solid state electrolyte 206 and the nanostructured transition metal oxide bronze of the working electrode 204 as a result of the applied voltage. Specifically, the application of voltage within the particular range may cause the second dopant species to intercalate and deintercalate the transition metal oxide structure. In this manner, the second dopant may cause a change in the oxidation state of the transition metal oxide, which may cause a polaron effect and a shift in the lattice structure of the transition metal oxide. This shift may cause absorption of visible radiation, for example, at wavelengths of around 400-780 nm.

In various embodiments, the second dopant species may be an intercalation ion species selected from the group of lanthanides (e.g., cerium, lanthanum, praseodymium, neodymium, promethium, samarium, europium, gadolinium, terbium, dysprosium, holmium, erbium, thulium, ytterbium, and lutetium), alkali metals (e.g., lithium, sodium, potassium, rubidium, and cesium), and alkali earth metals (e.g., beryllium, magnesium, calcium, strontium, and barium). In other embodiments, the second dopant species may include a charged proton species.

In various embodiments, nanostructures 213 may be mixed with the doped transition metal oxide bronze nanostructures 212 in the working electrode 204. In the various embodiments, the nanostructures 213 may include at least one TCO composition, which prevents UV radiation from reaching the electrolyte and generating electrons. In an exemplary embodiment, the nanostructures 213 may include an indium tin oxide (ITO) composition, which may be a solid solution of around 60-95 wt % (e.g., 85-90 wt %) indium(III) oxide (In₂O₃) and around 5-40 wt % (e.g., 10-15 wt %) tin(IV) oxide (SnO₂). In another exemplary embodiment, the nanostructures 213 may include an aluminum-doped zinc oxide (AZO) composition, which may be a solid solution of around 99 wt % zinc oxide (ZnO) and around 2 wt % aluminum(III) oxide (Al₂O₃). Additional or alternative TCO compositions that may be used to form nanostructures 213 in the various embodiments include, but are not limited to, indium oxide, zinc oxide and other doped zinc oxides such as gallium-doped zinc oxide and indium-doped zinc oxide.

The TCO composition of nanostructures 213 may be transparent to visible light and, upon application of the first voltage, may modulate absorption of NIR radiation at wavelengths of around 1200-2500 nm, with peak absorbance around 2000 nm (e.g., at a longer peak wavelength than the bronze nanoparticles 212, but with overlapping absorption bands). In particular, application of the first voltage may cause an increase in free electron charge carriers, and therefore cause a surface plasmon resonance effect in at least one TCO composition of nanostructures 213. In an embodiment in which the TCO composition is ITO, the surface plasmon resonance effect may be caused by oscillation of free electrons produced by the replacement of indium ions (In3+) with tin ions (Sn4+). Similar to the transition metal oxide bronze, such surface plasmon resonance may cause a change in absorption properties of the TCO material. In some embodiments, the change in absorption properties may be an increase in absorbance of NIR radiation at wavelengths that overlaps with that of the nanostructures 212. Therefore, the addition of TCO composition nanostructures 213 to the working electrode 204 may serve to expand the range of NIR radiation absorbed (e.g., at wavelengths of around 780-2500 nm) compared to that of the nanostructures 212 alone (e.g., at wavelengths of around 780-2000 nm), and to enhance absorption of some of that NIR radiation (e.g., at wavelengths of around 1200-2000 nm).

Based on these optical effects, the nanostructure 212 and optional nanostructure 213 of the working electrode may progressively modulate transmittance of NIR and visible radiation as a function of applied voltage by operating in at least three different modes. For example, a first mode may be a highly solar transparent (“bright”) mode in which the working electrode 204 is transparent to NIR radiation and visible light radiation. A second mode may be a selective-IR blocking (“cool”) mode in which the working electrode 204 is transparent to visible light radiation but absorbs NIR radiation. A third mode may be a visible blocking (“dark”) mode in which the working electrode 204 absorbs radiation in the visible spectral region and at least a portion of the NIR spectral region. In an example, application of a first voltage having a negative bias may cause the electrochromic device to operate in the cool mode, blocking transmittance of NIR radiation at wavelengths of around 780-2500 nm. In another example, application of a second negative bias voltage having a higher absolute value than the first voltage may cause the electrochromic device to operate in the dark state, blocking transmittance of visible radiation (e.g., at wavelengths of around 400-780 nm) and NIR radiation at wavelengths of around 780-1200 nm. In another example, application of a third voltage having a positive bias may cause the electrochromic device to operate in the bright state, allowing transmittance of radiation in both the visible and NIR spectral regions. In various embodiments, the applied voltage may be between −5V and 5V, preferably between −2V and 2V. For example, the first voltage may be −0.25V to −0.75V, and the second voltage may be −1V to −2V. In another example, the absorbance of radiation at a wavelength of 800-1500 nm by the electrochromic device may be at least 50% greater than its absorbance of radiation at a wavelength of 450-600 nm. Alternatively, the nanostructure 212 and optional nanostructure 213 of the working electrode may modulate transmittance of NIR and visible radiation as a function of applied voltage by operating in two different modes. For example, a first mode may be a highly solar transparent (“bright”) mode in which the working electrode 204 is transparent to NIR radiation and visible light radiation. A second mode may be a visible blocking (“dark”) mode in which the working electrode 204 absorbs radiation in the visible spectral region and at least a portion of the NIR spectral region. In an example, application of a first voltage having a negative bias may cause the electrochromic device to operate in the dark mode, blocking transmittance of visible and NIR radiation at wavelengths of around 780-2500 nm. In another example, application of a second voltage having a positive bias may cause the electrochromic device to operate in the bright mode, allowing transmittance of radiation in both the visible and NIR spectral regions. In various embodiments, the applied voltage may be between −2V and 2V. For example, the first voltage may be −2V, and the second voltage may be 2V. In various embodiments, the solid state electrolyte 206 may include at least a polymer material and a plasticizer material, such that electrolyte may permeate into crevices between the transition metal oxide bronze nanoparticles 212 (and/or nanoparticles 213 if present). The term “solid state,” as used herein with respect to the electrolyte 206, refers to a polymer-gel and/or any other non-liquid material. In some embodiments, the solid state electrolyte 206 may further include a salt containing, for example, an ion species selected from the group of lanthanides (e.g., cerium, lanthanum, praseodymium, neodymium, promethium, samarium, europium, gadolinium, terbium, dysprosium, holmium, erbium, thulium, ytterbium, and lutetium), alkali metals (e.g., lithium, sodium, potassium, rubidium, and cesium), and alkali earth metals (e.g., beryllium, magnesium, calcium, strontium, and barium). In an exemplary embodiment, such salt in the solid state electrolyte 206 may contain a lithium and/or sodium ions. In some embodiments, the solid state electrolyte 206 may initially contain a solvent, such as butanol, which may be evaporated off once the electrochromic device is assembled. In some embodiments, the solid state electrolyte 206 may be around 40-60 wt % plasticizer material, preferably around 50-55 wt % plasticizer material. In an embodiment, the plasticizer material may include at least one of tetraglyme and an alkyl hydroperoxide. In an embodiment, the polymer material of the solid state electrolyte 206 may be polyvinylbutyral (PVB), and the salt may be lithium bis(trifluoromethane). In other embodiments, the solid state electrolyte 206 may include at least one of lithium phosphorus oxynitride (LiPON) and tantalum pentoxide (Ta2O5).

In some embodiments, the electrolyte 206 may include a sacrificial redox agent (SRA). Suitable classes of SRAs may include, but are not limited to, alcohols, nitrogen heterocycles, alkenes, and functionalized hydrobenzenes. Specific examples of suitable SRAs may include benzyl alcohol, 4-methylbenzyl alcohol, 4-methoxybenzyl alcohol, dimethylbenzyl alcohol (3,5-dimethylbenzyl alcohol, 2,4-dimethylbenzyl alcohol etc.), other substituted benzyl alcohols, indoline, 1,2,3,4-tetrahydrocarbazole, N,N-dimethylaniline, 2,5-dihydroanisole, etc. In various embodiments, the SRA molecules may create an air stable layer that does not require an inert environment to maintain charge.

Polymers that may be part of the electrolyte 206 may include, but are not limited to, poly(methyl methacrylate) (PMMA), poly(vinyl butyral-co-vinyl alcohol-co-vinyl acetate) (PVB), poly(ethylene oxide) (PEO), fluorinated co-polymers such as poly(vinylidene fluoride-co-hexafluoropropylene), poly(acrylonitrile) (PAN), poly(vinyl alcohol) (PVA), etc. Plasticizers that may be part of the polymer electrolyte formulation include, but are not limited to, glymes (tetraglyme, triglyme, diglyme etc.), propylene carbonate, ethylene carbonate, ionic liquids (1-ethyl-3-methylimidazolium tetrafluoroborate, 1-butyl-3-methylimidazolium hexafluorophosphate, 1-butyl-3-methylimidazolium bis(trifluoromethane sulfonyl) imide, 1-butyl-1-methyl-pyrrolidinium bis(trifluoromethane sulfonyl)imide, etc.), N,N-dimethylacetamide, and mixtures thereof.

In some embodiments, the electrolyte 206 may include, by weight, 10-30% polymer, 40-80% plasticizer, 5-25% lithium salt, and 0.5-10% SRA.

The counter electrode 208 of the various embodiments should be capable of storing enough charge to sufficiently balance the charge needed to cause visible tinting to the nanostructured transition metal oxide bronze in the working electrode 204. In various embodiments, the counter electrode 208 may be formed as a conventional, single component film, a nanostructured film, or a nanocomposite layer.

In some embodiments, the counter electrode 208 may be formed from at least one passive material that is optically transparent to both visible and NIR radiation during the applied biases. Examples of such passive counter electrode materials may include CeO₂, CeVO₂, TiO₂, indium tin oxide, indium oxide, tin oxide, manganese or antimony doped tin oxide, aluminum doped zinc oxide, zinc oxide, gallium zinc oxide, indium gallium zinc oxide, molybdenum doped indium oxide, Fe₂O₃, and/or V₂O₅. In other embodiments the counter electrode 208 may be formed from at least one complementary material, which may be transparent to NIR radiation but which may be oxidized in response to application of a bias, thereby causing absorption of visible light radiation. Examples of such complementary counter electrode materials may include Cr₂O₃, MnO₂, FeO₂, CoO₂, NiO₂, RhO₂, or IrO₂. The counter electrode materials may include a mixture of one or more passive materials and/or one or more complementary materials described above.

Without being bound to any particular theory, it is believed that the application of a first voltage in the various embodiments may cause the interstitial dopant species (e.g., cesium) in the crystal structure of the transition metal oxide bronze to have a greater amount of free carrier electrons and/or to cause the interstitial dopant species (e.g., lithium ions from the electrolyte) to perform non-faradaic capacitive or pseudo-capacitive charge transfer on the surface of the nanostructures 212, which may cause the surface plasmon resonance effect to increase the absorption of NIR radiation. In this manner, the absorption properties of the transition metal oxide bronze characteristics may change (i.e., increased absorption of NIR radiation) upon application of the first voltage. Further, application of a second voltage having a higher absolute value than the first voltage in the various embodiments may cause faradaic intercalation of an intercalation dopant species (e.g., lithium ions) from the electrolyte into the transition metal oxide nanostructures. It is believed that the interaction of this dopant species provides interstitial dopant atoms in the lattice which creates a polaron effect. In this manner, the lattice structure of transition metal oxide nanoparticles may experience a polaron-type shift, thereby altering its absorption characteristics (i.e., shift to visible radiation) to block both visible and near infrared radiation.

In some embodiments, in response to radiation of certain spectral regions, such as UV (e.g., at wavelengths of around 10-400 nm) may cause excitons to be generated in the polymer material of the solid state electrolyte 206. The UV radiation may also excite electrons in the doped transition metal oxide bronze to move into the conduction band, leaving holes in the valence band. The generated excitons in the polymer material may dissociate to free carriers, the electrons of which may be attracted to the holes in the valence band in the doped transition metal oxide bronze (e.g., cesium-doped tungsten trioxide (CsₓWO₃)) of nanoparticles 212. Since electrochemical reduction of various transition metal oxide bronzes by such free electron charge carriers may degrade their performance (i.e., from unwanted coloration of the transition metal oxide bronze), embodiment devices may include one or more layer of a protective material to prevent UV radiation from reaching the solid state electrolyte 206, in addition to or instead of nanostructures 213 mixed into the working electrode.

FIG. 2B illustrates an embodiment electrochromic device 250 that addresses degradation of the doped transition metal oxide bronze nanostructures 212. Similar to the electrochromic device 200 shown in FIG. 2A, the electrochromic device 250 may include a first transparent conductor layer 202a, a working electrode 204, a solid state electrolyte 206, a counter electrode 208, a second transparent conductor layer 202b, and first and/or second light transmissive substrates 210a, 210b. In addition, the electrochromic device 250 may include one or more protective layers 216a, 216b made of a material that absorbs UV radiation. In an exemplary embodiment, the electrochromic device 250 may include a first protective layer 216a disposed between the first substrate 210a and the first transparent conductor layer 202a. The electrochromic device 250 may optionally include a second protective layer 216b disposed between the second substrate 210b and the second transparent conductor layer 202b. Alternatively, the UV protective layer 216a may be disposed on the outer surface of the first substrate 210a, or may be disposed between the first transparent conductor 202a and the working electrode 204. In other words, the first and/or second UV protective layers 216a, 216b may be disposed between any of the layers of the electrochromic device 250, such that UV radiation is substantially prevented from reaching the working electrode 204.

The UV radiation absorbing material of the one or more protective layers 216a, 216b of the various embodiments may be any of a number of barrier films. For example, the one or more protective layer 216a may be a thin film of at least one TCO material, which may include a same as or different from TCO compositions in the nanostructures 213. In an exemplary embodiment, a protective layer 216a of the device 250 may be an ITO thin film, and therefore capable of absorbing UV radiation by band-to-band absorption (i.e., absorption of a UV photon providing enough energy to excite an electron from the valence band to the conduction band). In another exemplary embodiment, the device may include the TCO nanostructures 213 made of ITO, as well as a protective layer 216a composed of an ITO thin film. Alternatively, the TCO nanostructures 213 may form a separate thin film layer 216b disposed between the transition metal oxide bronze nanoparticles 212 and the transparent conductor 202a. In some embodiments, the UV radiation absorbing materials of protective layers 216a, 216b may include organic or inorganic laminates.

In another embodiment, at least one UV protective layer, such as protective layer 216a in FIG. 2B, may be a UV radiation reflector made of a high index transparent metal oxide. Since birds can see radiation in the UV range, a UV reflector may be implemented in embodiments positioned as outside windows in order to prevent birds from hitting the windows. In some other embodiments, UV radiation absorbing organic molecules and/or inorganic UV radiation absorbing nanoparticles (e.g., zinc oxide, indium oxide, ITO, etc.) may be incorporated within the electrolyte 206 material.

FIG. 2C illustrates another embodiment electrochromic device 270 that addresses degradation of the doped transition metal oxide bronze nanostructures 212 by controlling the effects of the electron charge carriers generated in the electrolyte from exposure to UV radiation. Similar to devices 200 and 250 discussed above with respect to FIGS. 2A and 2B respectively, the electrochromic device 270 may include a first transparent conductor layer 202a, a working electrode 204, a solid state electrolyte 206, a counter electrode 208, a second transparent conductor layer 202b, and first and/or second light transmissive substrates 210a, 210b. In addition, electrochromic device 270 may include a protective layer 218 positioned between the working electrode 204 and the electrolyte 206. The protective layer 218 may be composed of one or more ionically conductive and electrically insulating material.

As discussed above, without being bound to any particular theory, it is believed that the migration of intercalation ions between the electrolyte 206 and the working electrode 204 is responsible for at least some of the device's capability to modulate spectral absorption. Therefore, in order to maintain operability of the device, the electrically insulating material used to form the protective layer 218 should also be ionically conductive. That is, the material of the protective layer 218 may prevent or reduce free electrons in the solid state electrolyte layer 206 from reducing the transition oxide bronze of nanoparticles 212, while allowing the diffusion of ions of an intercalation dopant species (e.g., Na, Li, etc.) between the electrolyte 206 and working electrode 204. In an exemplary embodiment, the electrically insulating material that makes up the protective layer 218 may be tantalum oxide, such as tantalum pentoxide (Ta₂O₅), which blocks migration of electrons from the electrolyte 206 while allowing diffusion of the intercalation dopant species ions (e.g., lithium ions) from the electrolyte 206. In this manner, degradation of the transition metal oxide bronze is reduced or prevented by controlling the effect of the absorbed UV radiation in addition to or instead of instead of blocking its absorption. Other example materials that may be used to form the protective layer 218 in addition to or instead of tantalum pentoxide may include, without limitation, strontium titanate (SrTiO3), zirconium dioxide (ZrO2), indium oxide, zinc oxide, tantalum carbide, niobium oxide, and various other dielectric ceramics having similar electrical and/or crystalline properties to tantalum pentoxide.

In an alternative embodiment, instead of or in addition to the protective layer 218, the nanostructures 212 may each be encapsulated in a shell containing an electrically insulating and ionically conductive material, which may be the same as or different from the material of the protective layer 218 (e.g., tantalum oxide, strontium titanate, zinc oxide, indium oxide, zirconium oxide, tantalum carbide, or niobium oxide).

In an exemplary embodiment, each nanostructure 212 may have a core of cubic or hexagonal unit cell lattice structure tungsten bronze, surrounded by a shell of tantalum pentoxide.

In some embodiments, the electrolyte 206 may include a polymer that reduces damage to the device due to UV radiation. The polymer may be any of a number of polymers that are stable upon absorption of UV radiation (e.g., no creation of proton/electron pairs). Examples of such polymers may include, but are not limited to, fluorinated polymers without hydroxyl (-OH) groups (e.g., polyvinylidene difluoride (PVDF)).

In another embodiment, a positive bias may be applied to the counter electrode 208 to draw UV radiation generated electrons from the electrolyte 206 to the counter electrode 208 in order to reduce or prevent electrons from the electrolyte 206 from moving to the working electrode 204 to avoid the free electron-caused coloration of the doped transition metal oxide bronze in the working electrode 204.

In another embodiment, a device may include more than one of, such as any two of, any three of, or all four of: (i) a protective layer of electrically insulating material (e.g., protective layer 218 or protective material shells around the bronze nanoparticles), (ii) one or more protective layer of UV radiation absorbing material (e.g., protective layer(s) 216a and/or 216b in FIG. 2B and/or UV radiation absorbing organic molecules and/or inorganic UV radiation absorbing nanoparticles incorporated within the electrolyte 206 material), (iii) electrolyte polymer that is stable upon absorption of UV radiation, and/or (iv) application of positive bias to the counter electrode 208. In various embodiments, the nanostructures 213 may be included in or omitted from electrochromic devices 250, 270.

In another embodiment, the protective layer(s) 216a and/or 216b may comprise a stack of metal oxide layers. Alternatively, the stack may comprise a separate component that is provided instead of or in addition to the layer(s) 216a and/or 216b. The stack may provide improvement in the reflected color of the electrochromic device. Prior art devices generally have a reddish/purplish color when viewed in reflection. The stack may comprise index-matched layers between the glass and transparent conductive oxide layer to avoid the reddish/purplish reflected color. As noted above, the index-matched layer can serve as the UV absorber or be used in addition to another UV absorber. The stack may comprise a zinc oxide based layer (e.g., ZnO or AZO) beneath an indium oxide based layer (e.g., indium oxide or ITO).

Compared to nanocomposite electrochromic films, the various embodiments may involve similar production by utilizing a single nanostructured material in the working electrode to achieve the desired spectral absorption control in both NIR and visible regions, and another nanostructured material to enhance and expand such control in the NIR region. Further, the various embodiments may provide one or more additional layer(s) of a protective material to minimize degradation of the single nanostructured material.

In some embodiments, the working electrode and/or the counter electrode may additionally include at least one material, such as an amorphous nano structured material, that enhances spectral absorption in the lower wavelength range of the visible region. In some embodiments, the at least one amorphous nanostructured material may be at least one nanostructured amorphous transition metal oxide.

In particular, the amorphous nano structured materials may provide color balancing to the visible light absorption that may occur due to the polaron-type shift in the spectral absorption of the doped-transition metal oxide bronze. As discussed above, upon application of the second voltage having a higher absolute value, the transition metal oxide bronze may block (i.e., absorb) radiation in the visible range. In various embodiments, the absorbed visible radiation may have wavelengths in the upper visible wavelength range (e.g., 500-700 nm), which may cause the darkened layer to appear blue/violet corresponding to the un-absorbed lower visible wavelength range (e.g., around 400-500 nm). In various embodiments, upon application of the second voltage, the at least one nanostructured amorphous transition metal oxide may absorb complementary visible radiation in the lower visible wavelength range (e.g., 400-500 nm), thereby providing a more even and complete darkening across the visible spectrum with application of the second voltage. That is, use of the amorphous nanostructured material may cause the darkened layer to appear black.

In some embodiments, at least one nanostructured amorphous transition metal oxide may be included in the working electrode 204 in addition to the doped-transition metal oxide bronze nanostructures 212 and the TCO nanostructures 213. An example of such material in the working electrode 204 may be, but is not limited to, nanostructured amorphous niobium oxide, such as niobium(II) monoxide (NbO) or other niobium oxide materials (e.g., NbOₓ). In some embodiments, the counter electrode 208 may include, as a complementary material, at least one nano structured amorphous transition metal oxide. That is, in addition to optically passive materials, the counter electrode 208 may include at least one material for color balancing (i.e., complementing) the visible radiation absorbed in the working electrode (i.e., by the transition metal oxide bronze. An example of such material in the counter electrode 208 may be, but is not limited to, nanostructured amorphous nickel oxide, such as nickel(II) oxide (NiO) or other nickel oxide materials (e.g., NiOₓ).

In the various embodiments, nanostructures that form the working and/or counter electrode, including the at least one amorphous nanostructured material, may be mixed together in a single layer. An example of a mixed layer is shown in FIG. 2A with respect to transition metal oxide bronze nanostructures 212 and TCO nanostructures 213. Alternatively, nano structures that form the working and/or counter electrode, including the at least one amorphous nanostructured material, may be separately layered according to composition. For example, a working electrode may include a layer of amorphous NbOₓ nanostructures, a layer of transition metal oxide bronze nanostructures, and a layer of ITO nanostructures, in any of a number of orders.

The nanostructured transition metal oxide bronzes that may be part of the working electrode 204 in various embodiment devices can be formed using any of a number of low cost solution process methodologies. For example, solutions of Nb:TiO₂ and CsₓWO₃ may be synthesized using colloidal techniques. Compared to other synthetic methodologies, colloidal synthesis may offer a large amount of control over the nanostructure size, shape, and composition of the nanostructured transition metal oxide bronze. After deposition, a nanostructured transition metal oxide bronze material in the working electrode 204 may be subjected to a thermal post treatment in air to remove and cap ligands on the surface of the nanostructures.

In various embodiments, nanostructured amorphous transition metal oxide materials may be formed at room temperature from an emulsion and an ethoxide precursor. For example, procedures used to synthesize tantalum oxide nanoparticles that are described in “Large-scale synthesis of bioinert tantalum oxide nanoparticles for X-ray computed tomography imaging and bimodal image-guided sentinel lymph node mapping” by MH Oh et al. (J Am Chem Soc. 2011 Apr. 13; 133(14):5508-15), incorporated by reference herein, may be similarly used to synthesize amorphous transition metal oxide nanoparticles. For example, an overall synthetic process of creating the nanoparticle, as described in Oh et al., may adopted from the microemulsion synthesis of silica nanoparticles. In such process, a mixture of cyclohexane, ethanol, surfactant, and a catalysis for the sol-gel reaction may be emulsified. The ethoxide precursor may be added to the emulsion, and uniform nanoparticles may be formed by a controlled-sol gel reaction in the reverse micelles at room temperature within around 5 minutes. The sol-gel reaction may be catalyzed, for example, by NaOH.

In some embodiments, the nanostructured amorphous transition metal oxide may be sintered at a temperature of at least 400° C. for at least 30 minutes, such as 400 to 600° C. for 30 to 120 minutes to form a porous web. In an exemplary embodiment, the porous web may be included in a working electrode 204, with the tungsten bronze nanoparticles and ITO nanoparticles incorporated in/on the web. Alternatively, the sintering step may be omitted and the nano structured amorphous transition metal oxide may remain in the device in the form of nanoparticles having amorphous structure. In this embodiment, the device containing the nanostructured amorphous transition metal oxide may include or may omit the protective layer(s) 216a, 216b, and/or 218, the UV stable electrolyte polymer, and the application of positive bias to the counter electrode.

Electrochromic responses of prepared nano structured transition metal oxide bronze materials (e.g., CsₓWO₃, Nb:TiO₂, etc.) may be demonstrated by spectro-electrochemical measurements.

In various embodiments, the shape, size, and doping levels of nanostructured transition metal oxide bronzes may be tuned to further contribute to the spectral response by the device. For instance, the use of rod versus spherical nanostructures 212 may provide a wider level of porosity, which may enhance the switching kinetics. Further, a different range of dynamic plasmonic control may occur for nanostructures with multiple facets, such as at least 20 facets.

Various embodiments may also involve alternation of the nanostructures 212 that form the working electrode 204. For example, the nanostructures may be nanoparticles of various shapes, sizes and/or other characteristics that may influence the absorption of NIR and/or visible light radiation. In some embodiments, the nanostructures 212 may be isohedrons that have multiple facets, preferably at least 20 facets.

In some embodiments, the transition metal oxide bronze nanostructures 212 may be a combination of nanoparticles having a cubic unit cell crystal lattice (“cubic nanoparticles”) and nanoparticles having a hexagonal unit cell crystal lattice (“hexagonal nanoparticles”). Each unit cell type nanoparticle contributes to the performance of the working electrode 204. For example, the working electrode 204 may include both cubic and hexagonal cesium doped tungsten oxide bronze nanoparticles. In alternative embodiments, the working electrode 204 may include either cubic or hexagonal cesium doped tungsten oxide nanoparticles. For example, the working electrode 204 may include cubic cesium-doped tungsten oxide (e.g. Cs₁W₂O_{6-X}) nanoparticles and amorphous niobium oxide nanoparticles or hexagonal cesium-doped tungsten oxide (e.g. Cs_{0.29}W₁O₃) nanoparticles without niobium oxide. In alternative embodiments, the working electrode 204 may include undoped tungsten oxide (e.g. WO_{3-X}) nanoparticles where 0≤X≤0.1.

For example, upon application of the first (i.e., lower absolute value) voltage described above, the hexagonal bronze nanostructures 212 may block NIR radiation having wavelengths in the range of around 800-1700 nm, with the peak absorption at the mid-NIR wavelength of around 1100 nm. The cubic bronze nanostructures 212 may block NIR radiation having wavelengths in the close-NIR range with the peak absorption of around 890 nm. The indium oxide based (including ITO) and/or zinc oxide based (including AZO) nanostructures 213 may be included in the working electrode 204 to block the higher wavelength IR radiation upon application of the first voltage. Thus, the cubic bronze and hexagonal bronze nanostructures may block respective close and mid-NIR radiation (e.g., using the Plasmon effect), while the nanostructures 213 may block the higher wavelength IR radiation.

Upon application of the second (i.e., higher absolute value) voltage described above, the cubic bronze nanostructures 212 may block visible and NIR radiation having wavelengths in the range of around 500-1500 nm, with the peak absorption at the close-NIR wavelength of around 890 nm (e.g., using the polaron effect). Optionally, the amorphous niobium oxide may also be added to the working electrode 204 to block the short wavelength visible radiation (e.g., 400 to 500 nm wavelength).

The cubic bronze nanostructures block visible radiation via the polaron effect at a lower applied voltage than the hexagonal bronze nanostructures. Thus, the second voltage may have an absolute value which is below the value at which the hexagonal bronze nano structures block visible radiation via the polaron effect such that these nanostructures do not contribute to blocking of visible radiation. Alternatively, the second voltage may have an absolute value which is above the value at which the hexagonal bronze nanostructures block visible radiation via the polaron effect such that these nanostructures also contribute to blocking of visible radiation.

Embodiment nanoparticles that form the working electrode 204 may be around 4-6 nm in diameter, and may include 40 to 70 wt %, such as around 50 wt % cubic tungsten bronze nanostructures, 15 to 35 wt %, such as around 25 wt % hexagonal tungsten bronze nanostructures, and optionally 15 to 35 wt %, such as around 25 wt % ITO nanostructures. In some embodiments, in order to achieve color balancing as described above, the nanoparticles that form the working electrode 204 may optionally include around 5-10 wt % amorphous NbOₓ nanostructures in place of cubic tungsten bronze nanostructures. In this embodiment, the device containing two types of bronze nanoparticles may include or may omit the protective layer(s) 216a, 216b, and 218, the UV stable electrolyte polymer, the application of positive bias to the counter electrode, and the amorphous niobium oxide.

In summary, the working electrode 204 may include one or more of the following components:

(a) metal oxide bronze nanostructures 212 having (i) a cubic, (ii) hexagonal, or (iii) a combination of cubic and hexagonal unit cell lattice structure;

(b) protective (i) indium oxide based (including ITO) and/or zinc oxide based (including AZO) nanostructures 213;

(c) amorphous niobium oxide nanoparticles and/or web; and/or

(d) additional nanostructures selected from undoped tungsten oxide, molybdenum oxide, titanium oxide, and/or vanadium oxide.

The counter electrode 208 may include one or more of the following components:

(a) passive electrode material selected from cerium(IV) oxide (CeO₂), titanium dioxide (TiO₂), cerium(III) vanadate (CeVO₂), indium(III) oxide (In₂O₃), tin-doped indium oxide, tin(II) oxide (SnO₂), manganese-doped tin oxide, antimony-doped tin oxide, zinc oxide (ZnO), aluminum-doped zinc oxide (AZO), iron(III) oxide (Fe₂O₃), and vanadium(V) oxide (V₂O₅);

(b) an active electrode material selected from chromium(III) oxide (Cr₂O₃), manganese dioxide (MnO₂), iron(II) oxide (FeO), cobalt oxide (CoO), nickel(II) oxide (NiO), rhodium(IV) oxide (RhO₂), and iridium(IV) oxide (IrO₂);

(c) amorphous nickel oxide nanoparticles and/or web; and/or

(d) conductivity enhancer nanoparticles selected from indium oxide, ITO, and zinc oxide.

While the various embodiments are described with respect to electrochromic windows, the embodiment methods, systems, and devices may also be used in materials for other types of smart windows. Such smart windows may include, but are not limited to, polymer-dispersed liquid crystals (PLDD), liquid crystal displays (LCDs), thermochromics, etc.

The smart windows disclosed herein may be integrated with a building management system (BMS) through window control units, as described above with respect to FIG. 1.

In one embodiment, a window control unit may receive input from various power generation units that operate as sensors. The window control unit may process the inputs to determine a desired optical state for a smart window using, for example, a function or a lookup table. In some embodiments, the function or lookup table may change with the time of day or the day of the year to account for the changes in sunlight incident upon the smart window. In some embodiments, at least one of the power generation devices may serve as a voltage or current source for switching an optical state of the electrochromic device. Further, the smart windows and window control unit(s) may be integrated into a building management system by wired or wireless network. In some embodiments, the window control unit(s) may interface with the different systems of the building to aid in the control of the environment in the building. In an alternative embodiment, the window control unit may receive input from a power generation device that is not a sensor.

In various embodiments, the power generation device(s) may be formed in a variety of configurations in order to avoid impeding the appearance and/or function of the smart windows. For example, a power generation device may be a specialized coating layered on a window (e.g., on the glass pane). In another example, a power generation device may be a plurality of sensors that are embedded in one or more layer of the smart window (e.g., the glass pane).

In some embodiments, a power generation device may be positioned at the edge of the window as strips located on a window frame or on the edge of the glass pane. Some embodiment power generation devices (e.g., photovoltaic cells) may be configured as individual nanoscale devices that are not visible to the human eye. As such, a power generation device may be created with a plurality of such nanoscale devices spread out over a window layer in a mesh pattern/overlay. As a result, the lack of visibility of the power generation device(s) is maintained while providing a light transmissive window. In various embodiments, electrodes of nanoscale devices may be made of TCO materials.

In an example system that includes photovoltaic energy producing devices, a power generation device may be a plurality of photovoltaic cells that are configured with particular band gap(s) to absorb a subset of radiation wavelengths. For example, the power generation device may be configured to generate a voltage based only on UV radiation and optionally the violet/blue portion of visible radiation, without absorbing the remaining portion of visible radiation (e.g., red, yellow, and green). In an embodiment, a photovoltaic cell may have a bandgap of at least 3.1 eV (e.g., 3.1-4.1 eV) for absorbing UV radiation and transmitting all or most of visible radiation. In another embodiment, a photovoltaic cell may have a bandgap of at least 2.5 eV (e.g., at least 2.5-4.1 eV) for absorbing UV radiation and the violet/blue portion of visible radiation, and transmitting the red/yellow/green portion of visible radiation. In another embodiment, each photovoltaic cell may have a bandgap that enables the cell to absorb UV radiation and/or near-infrared (NIR) radiation.

In various embodiments, electrodes of the photovoltaic cells may be made of TCO materials. For example, the photovoltaic device 318 may be deposited on the inside or outside of the glass pane 316. The electrochromic device 302 may be deposited over the photovoltaic device 318 if device 318 is located on the inside of the glass pane 316, with a transparent insulating layer separating the electrodes of the devices 318 and 302. Alternatively, the electrochromic device 302 may be deposited on the inside of the glass pane 316 of the photovoltaic device is located on the outside of the glass pane 316. In this manner, the UV absorbing photovoltaic device 318 may act as a UV barrier for the electrochromic device 302.In various embodiments, at least one electrochromic device may be deposited on the inside surface of a glass pane or other transparent substrate, and at least one power generation device may be provided in any of a number of positions, as will be described in more detail below. In various embodiments, the power generation device and a battery may be connected in parallel to the electrochromic device via appropriate switching to allow selective activation of the electrochromic device to either a bright (e.g., bleached, substantially transparent) state or a dark (e.g., substantially opaque) state. It can also be set for any desired state of partial transparency or opacity between those two limits. In an exemplary embodiment, the power generation device may be an array of photovoltaic cells of a type well known in the art. For example, the array of photovoltaic cells may be deposited on an inner surface of a glass pane or other transparent substrate adjacent to or interspersed with the at least one electrochromic device. The photovoltaic cells may be formed by creating an n-type conductivity region on a surface of a p-type polycrystalline silicon substrate, and disposing a plurality of transparent conductive contacts (e.g., TCO) on the same surface. In some embodiments, the surface and transparent conductive contacts may be covered by an anti-reflective coating. Each photovoltaic cell may be connected in a series or parallel manner to the other photovoltaic cells to form an array.

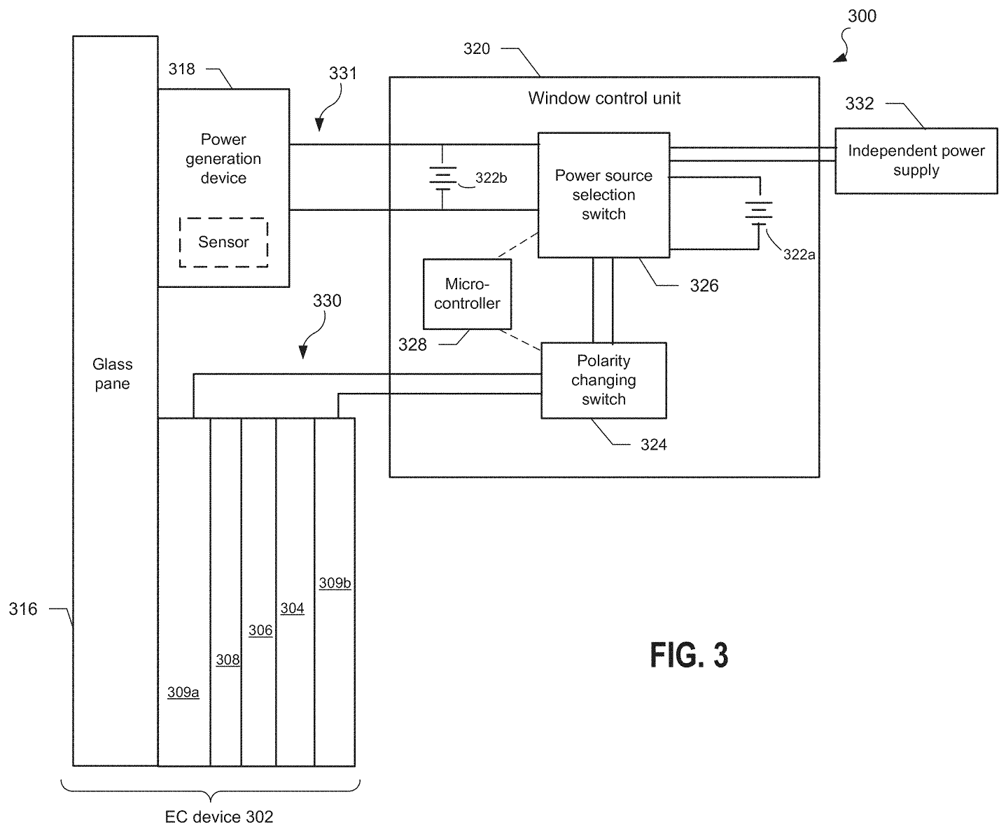

FIG. 3 is a schematic view of a smart window system 300 according to various embodiments of the present disclosure. Referring to FIG. 3, the smart window system includes an electrochromic device 302, which may be similar to any of the electrochromic devices discussed above. However, for simplicity, only a counter electrode 304, solid state electrolyte 306, working electrode 308, and first and second TCO layers 309a, 309b of the electrochromic device 302 are shown.

The smart window system 300 may include an inner pane and a frame (not shown). The frame may maintain the gap between the electrochromic device 302 and the inner pane. The gap may be maintained at below atmospheric pressure, may be filled with air, or may be filled with argon. The inner pane may be formed of glass or plastic and may be coated with a low-emissivity coating. The inner pane may be disposed inside of a building in which the smart window system 300 is mounted, with the electrochromic device 302 disposed toward the outside of the building.

A glass pane 316 forms the outermost layer of the smart window system 300. In some embodiments, the glass substrate of the electrochromic device 302 may form the glass pane 316 (or part thereof). For example, the substrate may be a glass pane 316 that is sized for residential or commercial window applications. In other embodiments, the glass pane 316 may be an additional glass layer overlaying the glass substrate of the electrochromic device 302. In various embodiments, the glass pane 316 may be made of any of a number of suitable materials, for example, clear or tinted soda lime glass, including soda lime float glass. Such glass may be tempered or untempered. In some embodiments, the glass pane 316 may be made of architectural glass or a mirror material.

The smart window system 300 may also include a power generation device 318, which may include one or more power generating units. While shown as adjacent to the glass pane 316, such position is merely representative, as the power generation device 318 may be provided in a number of different locations in various embodiments. In various embodiments, the power generation device 318 may be coated on the glass pane 316 or embedded in the glass pane 316.

For example, the power generation device 318 may be integrated with the smart window system 300 by being incorporated in, or positioned adjacent to, the glass pane 316. In other embodiments, the power generation device 318 may be integrated with the smart window system 300 by being attached to or incorporated a window frame. In various embodiments, the power generation device 318 may be coated on the glass pane 316 or embedded in the glass pane 316. Optionally, the power generation device 318 may include or be part of a device configured with a sensor.

While shown as part of a single unit, the power generating devices that make up the power generation device 318 may be positioned together or spaced apart, or applied in the form of a coating or mesh layer across the glass pane 316 or other transparent substrate.

A window control unit 320 may provide circuitry that connects and controls the operations of the power generation device 318 and electrochromic device 302. In particular, the window control unit 320 may include an energy storage device, such as a first battery 322a, and an alternative second energy storage device, such as a second battery 322b. The window control unit 320 may also include a polarity changing switch 324, a power source selection switch 326, and a microcontroller 328.

Wiring 330 may include various components (e.g., leads, bus bars, etc.) that connect the TCO layers 309a, 309b to provide the electric potential and a circuit across the electrochromic device 302, to affect changes in the transmissivity of the smart window. Specifically, wiring 330 may connect the electrochromic device 302 to the polarity reversing switch 324, which allows for the polarity of the charge across the electrochromic device to be reversed as part of the change in optical state. The polarity reversing switch 324 may be connected (e.g., in series) to the power source selection switch 326, which may be used to select between two alternate power sources to operate the electrochromic device 302—the first battery 322a and the power generation device 318.

In some embodiments, the power source selection switch 326 may provide access to at least a third alternate power source, such as an optional independent power supply 332 (e.g., a power grid). Wiring 331 may include various components (e.g., leads, bus bars, etc.) that connect the power generation device 318 to the window control unit 320 via the power source selection switch 326. In various embodiments, the power source selection switch 326 may receive power from the power generation device 318, and output the received power to the polarity changing switch 324 and/or to the first battery 322a. The power source selection switch 326 may also receive power from the independent power supply 332 (e.g., a power grid), and output the received power to the polarity changing switch 324 and/or to the first battery 322a. Further, the power source selection switch 326 may receive power from the first battery 322a and output the received power to the polarity changing switch 324.

In some embodiments, the microcontroller 328 may be configured with various algorithms, conditions, and/or settings to direct the power source selection switch 326 and the polarity changing switch 324. For example, the microcontroller 328 may detect voltage generated by a power generation device 318, and may determine a change in the optical state of the electrochromic device based on the detected voltage. The microcontroller 328 may calculate a magnitude and polarity of a bias voltage that should be applied to achieve the desired optical state. Based comparing the amount of power generated by the power generation device and the magnitude of the bias voltage, and/or other information (e.g., state of the first battery 322a, second battery 322b, power requirements of other systems in the building), the microcontroller 328 may send control signals directing whether the power from the power generation device 318 is supplied directly to the electrochromic device 302, or used to charge the first and/or second batteries 322a, 322b.

To apply the bias voltage, the microcontroller 328 may control the polarity changing switch 324, and if applicable, an amount of power drawn from the battery 322 or independent power supply 332. As discussed above, the bias voltage may drive a transition of the electrochromic device 302 from one optical state to another. In this manner, the microcontroller 328 may control the electrochromic device 302 to make the smart window system 300 more or less transmissive to light, thereby dynamically changing the amount of light that passes into the building from outside based on power from the power generation device 318, battery 322a /322b, and/or power supply 332.

According to various embodiments, power (e.g., a bias voltage) may be supplied the EC device 302 to change the optical state thereof. For example, energy by be applied to charge the EC device 302, such that the EC device 302 is switched from a thermodynamically low energy state to a thermodynamically high energy state, as measured by the open circuit voltage of the EC device 302. Typically, the high energy state corresponds to a dark (i.e., substantially opaque) optical state, and the low energy state corresponds to a bright optical state (e.g., a bleached or substantially transparent optical state).

Thermodynamically, there is driving force to equalize the electrochemical potentials of the working electrode 308 (Eworking_electrode) and the counter electrode 304 (Ecounter_electrode), such that (Eworking_electrode=Ecounter_electrode). The open circuit voltage (Eoc) of the EC device 302 may be equal to Eworking_electrode−Ecounter_electrode. Therefore, energy can be captured from the EC device 302 and stored in a battery or capacitor, when the EC device 302 transitions from the dark optical state (Eoc<0) until Eoc=0 in the bright optical state. Further, energy can be captured from the EC device 302, when the EC device 302 transitions from the bright optical State (Eoc>0) until Eoc=0. Going from Eoc=0 to any state generally requires energy, which can come from a power source, and will likely exceed that which was captured from transition from dark/bright State to the Eoc=0 condition, due to inefficiencies in energy transfer.

The system 300 may be configured to store energy released from the EC device 302, when the EC device 302 changes optical state. For example, the system 300 may be configured to store energy released from the EC device 302 in the energy storage device 322 (e.g., 322a and/or 322b), such as a battery or capacitor (e.g., ultracapacitor).

Optical state transition energy storage may be particularly applicable to EC devices 302 that are not connected to an independent power supply, such as the independent power supply 332 (e.g., power grid), or that are connected to an intermittent power supply. For example, when the EC device 302 relies upon a photovoltaic power generation device 318, the EC device 302 may receive a sporadic or insufficient amount of power. As such, stored transition energy in the energy storage device 322 may be used to supplement or replace power generated by the power generation device 318. Thus, the independent power supply 332 is optional.

In some embodiments, the EC device 302 may experience photochromic darkening, due to photochromic charge (e.g., photoelectrochemically generated charge) accumulation in the EC device 302. For example, exposure to UV light from the Sun may result in photochromic charge accumulation in the working electrode 308. The EC device 302 may experience unwanted darkening and reduction of light and unintentional onset of the dark optical state.

Accordingly, the smart window system 300 may also be configured to store the photochromic charge accumulated in the working electrode 308. For example, the control unit 320 may be configured to discharge the photochromic charge from the EC device 302 and store the same in the energy storage device 322, as disclosed above. Thus, energy from the EC device 302 may be provided for storage in the energy storage device 322 when the EC device is intentionally switched from one state to another (e.g., from the dark optical state to the bright optical state) and/or to remove photogenerated charge that accumulates in the EC device due to photochromic darkening.

Thus, in order to brighten an unintentionally photochromically darkened EC device, the microcontroller 328 may determine if the EC device has been intentionally set into the dark or the bright state. If it is determined that the EC device was set into the dark state, then no action is taken. If it is determined that the EC device was set into the bright state, but accumulated charge in excess of that expected in the bright state is detected in the EC device, then microcontroller 328 may release the excess charge to the energy storage device 322 to brighten the EC device. Thus, the photogenerated charge accumulated in the EC device due to photochromic darkening is removed for storage and the EC device is brightened to the bright state. As the photogenerated charge associated with this process is implicated in the loss of optical modulation in EC devices, the embodiment method has a two-fold benefit of mitigating UV degradation and capturing energy

In some embodiments, the power generation device 318 and a sensor may be provided within the same device, and/or used in combination. For example, a sensor/power generation device 318 may be a photodetector (PD) that measures the level of light transmitted through the EC device at a given optical state. The control unit 320 may be configured to use data from the PD to detect an amount of photochromic charge held in the working electrode 308.

Therefore, as described above, energy generated by the EC device 302 during a change in optical state of the EC device is stored in an energy storage device 322 selected from a battery and a capacitor. Tithe change of optical state of the EC device may comprise an intentional change from a dark optical state to a bright optical state of the EC device and/or may comprise photochromic darkening which results in accumulation of photochromic charge in the EC device. The method further includes removing the photochromic charge from the EC device 320 to brighten the EC device and to provide a current to the energy storage device 322 to store the energy. The method may include determining if the EC device 302 is set into a bright optical state and then only removing the photochromic charge from the EC device 302 if the EC device 302 is set into the bright optical state.

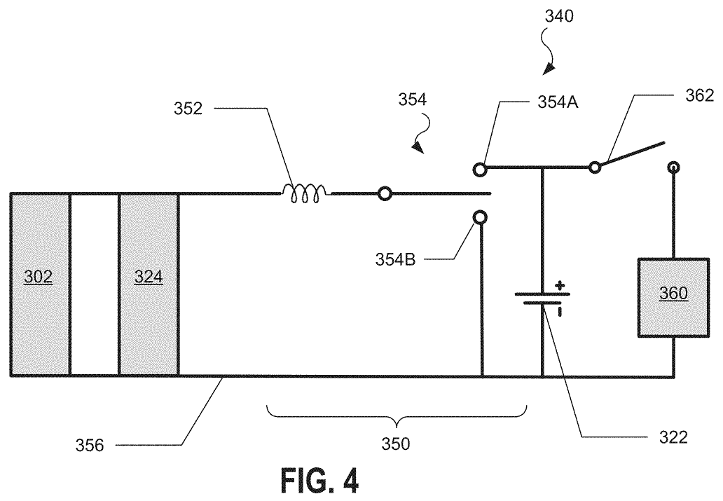

FIG. 4 is a schematic view of power control system 340, according to various embodiments of the present disclosure. Referring to FIGS. 3 and 4, the system 340 may include a DC/DC power converter 350 (e.g., a buck-boost DC/DC converter), the energy storage device 322, and an optional power source 360. The energy storage device 322 may be a battery or a capacitor. The energy storage device is shown as a battery 322 in shown in FIG. 4. Thus, the energy storage device may be referred to as battery 322 herein, for simplicity of explanation. In some embodiments, the battery 322 may be connected to the power supply 360 by wiring and a switch 362, such that the battery 322 may be charged by the power supply 360. The power supply 360 may include the power generation device 318 and/or the independent power supply 332, for example, and may also be used to provide power to the EC device 302. Alternatively, the power supply 360 may be connected to the EC device 302 using a different set of wires or contacts than the energy storage device 322.

Elements of the system 340 may be disposed in the control unit 320. For example, elements of the system 340 may be included in the power source selection switch 326. The polarity changing switch 324 may be electrically connected between the power control system 340 and the EC device 302. However, in other embodiments, the polarity changing switch may be included in the power source selection switch 326.

The converter 350 may include an inductor 352, a control switch 354, and wiring 356. The converter 350 may be electrically connected to terminals of the EC device 302 by the wiring 356. For example, the converter 350 may be connected to the TCO layers 309a, 309b of the EC device 302. Elements of the EC device 302 may operate as a capacitor and/or a resistor in the system 340. The control switch 354 may be a two-way switch including a first terminal 354A and a second terminal 354B.

The converter 350 may be configured to operate in a buck mode and a boost mode. In buck mode, the switch 354 may be set to connect the inductor 352 to the first terminal 354A, such that current from the battery 322 or power supply 360 flows into the inductor 352 and then into the EC device 302. As a result, a voltage may be applied to the EC device 302 to change the optical state thereof. The inductor 352 may reduce the current provided to the EC device and thereby reduce a voltage applied to the EC device 302. In buck mode, a voltage (Vin) provided from the battery 322 or the power supply 360 to the inductor 352 may be determined by a voltage of the battery 322 or the power supply 360, a voltage (Vout) output from the inductor 352 may be determined by the state of charge of the EC device 302, and Vout<Vin.

In boost mode, the switch 354 may connect the inductor 352 to the second terminal 354B to disconnect the inductor 352 from the battery 322, such that current from the EC device 302 accumulates in the inductor 352. For example, photochromic charge generated by UV light striking the EC device 302 and/or intentional switching of the EC device from the dark to the bright state may accumulate current in the inductor 352. When the switch 354 is controlled to connect the inductor 352 to the first terminal 354A in the boost mode, current accumulated in the inductor 352 may be provided for storage to the battery 322.

In boost mode, Vin from the EC device 302 to the inductor 352 is determined by the state of charge of the EC device 302, Vout is a charging voltage applied to the battery 322 from the inductor 352, and Vout>Vin. After the charge applied to the inductor 352 is depleted, the switch 354 may against connect the inductor 352 to the second terminal 354B and disconnect the inductor 352 from the battery 352. When the system 350 is not providing power to or receiving power from the EC device 302, the switch 354 may also be floated (i.e., to disconnect the inductor 352 from either terminal 354A or 354B) such that no current flows. Thus, the same converter 350 may be used in both buck and boost mode.

Thus, as described above, when the switch 354 is in a first position contacting terminal 354A, the energy storage device 322, the inductor 352, and the EC device 302 are electrically connected. When the switch 354 is in a second position contacting terminal 354B, the inductor and the EC device are electrically connected, and the energy storage device is electrically disconnected from the inductor and the EC device.

In the boost mode, the power converter 350 is configured to use the inductor 352 to accumulate current due to photochromic charge generated by UV light striking the EC device 302; and use the accumulated current to boost the voltage provided from the EC device 302 to the energy storage device 322.

In the buck mode, the switch 354 is configured to allow current to flow through the inductor 352 in a first direction, and in the boost mode, the switch is configured to allow the current to flow though the inductor in an opposing second direction.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

1. A smart window system, comprising:
an electrochromic (EC) device having a bright optical state and a dark optical state;
a DC/DC power converter electrically connected to the EC device and configured to operate in a buck mode and a boost mode; and
an energy storage device electrically connected to the power converter,
wherein:
in the buck mode, the power converter is configured to decrease a voltage provided through the power converter to the EC device; and
in the boost mode, the power converter is configured to increase a voltage provided from the EC device to the energy storage device.

2. The system of claim 1, wherein the power converter comprises:
an inductor electrically connected to the EC device; and
a switch configured to control current flow through the inductor.

3. The system of claim 2, wherein:
when the switch is in a first position, the energy storage device, the inductor, and the EC device are electrically connected; and
when the switch is in a second position, the inductor and the EC device are electrically connected, and the energy storage device is electrically disconnected from the inductor and the EC device.

4. The system of claim 2, wherein in the boost mode, the power converter is configured to use the inductor to:
accumulate current due to photochromic charge generated by UV light striking the EC device; and
use the accumulated current to boost the voltage provided from the EC device to the energy storage device.

5. The system of claim 2, wherein:
in the buck mode, the switch is configured to allow current to flow through the inductor in a first direction; and
in the boost mode, the switch is configured to allow the current to flow though the inductor in an opposing second direction.

6. The system of claim 1, wherein the energy storage device comprises a battery or a capacitor.

7. The system of claim 1, further comprising a power supply configured to provide power to the EC device, the energy storage device, or both the EC device and the energy storage device.

8. The system of claim 1, wherein the power supply comprises an independent power supply, a power generation device disposed in or on the smart window system, or both the independent power supply and the power generation device disposed in or on the smart window system.

9. The system of claim 8, wherein the power supply comprises the photovoltaic power generation device disposed in or on the smart window system.

10. The system of claim 1, wherein the EC device comprises:
a first transparent conductor layer;
a working electrode comprising a nanostructured electrochemically-active material;
a solid state electrolyte layer;
a counter electrode layer; and
a second transparent conductor layer.

11. A method of operating an electrochromic (EC) device, comprising storing energy generated by the EC device during a change in optical state of the EC device.

12. The method of claim 11, wherein the energy is stored in an energy storage device selected from a battery and a capacitor.

13. The method of claim 11, wherein the change of optical state of the EC device comprises an intentional change from a dark optical state to a bright optical state of the EC device.

14. The method of claim 11, wherein the change of optical state of the EC device comprises photochromic darkening which results in accumulation of photochromic charge in the EC device.

15. The method of claim 14, further comprising removing the photochromic charge from the EC device to brighten the EC device and to provide a current to an energy storage device to store the energy.

16. The method of claim 15, further comprising determining if the EC device is set into a bright optical state and removing the photochromic charge from the EC device if the EC device is set into the bright optical state.

17. The method of claim 11, further comprising:
operating a DC/DC power converter in a buck mode, such that the DC/DC power converter reduces a voltage provided to the EC device; and
operating the DC/DC power converter in a boost mode, such that the DC?DC power converter increases a voltage provided from the EC device to an energy storage device.

18. The method of claim 17, wherein the voltage provided from the EC device is provided during a change in the optical state of the EC device.

19. The method of claim 17, wherein the voltage provided from the EC device is provided to remove photochromic charge accumulated in the EC device.

20. The method of claim 17, wherein the DC/DC power converter comprises an inductor and a switch.

21. A smart window system, comprising
an electrochromic (EC) device having a bright optical state and a dark optical state;
an energy storage device electrically connected to the power converter; and
a conversion means for increasing a voltage provided to the EC device in a buck mode, and for increasing a voltage provided from the EC device to the energy storage device in a boost mode.
